(19) United States
(12) Patent Application Publication
(10) Pub. No.: US 2017/0129588 A1
(43) Pub. Date: May 11, 2017

(54) Truss-Reinforced Radome Crown Structure

(71) Applicant: Howard R. Verillion, JR., Northridge, CA (US)

(72) Inventor: Howard R. Verillion, JR., Northridge, CA (US)

(21) Appl. No.: 15/275,382

(22) Filed: Sep. 24, 2016

Related U.S. Application Data
(60) Provisional application No. 62/233,187, filed on Sep. 25, 2015.

(51) Int. Cl. B64C 1/36; H01Q 1/42; H01Q 1/28

(52) U.S. Cl. CPC B64C 1/36; H01Q 1/282; H01Q 1/42

(57) ABSTRACT

A truss-reinforced radome crown structure (TRRCS) that functions in combination with an aircraft and a communication radome or antenna. The TRRCS maintains and protects a radome and antenna located on an aircraft's fuselage. The TRRCS includes a fairing that is preferably elliptical shaped, a truss structure that is located within and circumvents the fairing, and truss/fairing attachment means that comprise a plurality of links/rods and pins or tubes, and/or exterior horizontal intercostal rods. Once the TRRCS is attached, a radome and antenna is enclosed and protected, and the design of the TRRCS allows it to compensate for the expansion and contraction as well as other forces experienced by an aircraft while in flight.

### TECHNICAL FIELD

The invention generally pertains to structures for communication systems, and more particularly for a truss-reinforced radome crown structure that provides attachment and support for a radome or antenna located on an aircraft.

### BACKGROUND ART

In the modem world, there are many methods of transportation. One of the most widely used methods, for trips of all distances and durations, is by aircraft, which are utilized for personal, commercial, military/government, and for other purposes. One of the most important aspects of modern aircraft is the use of advanced communication systems. A major component on many communication systems is a radome.

Typically, a radome is attached either within an aircraft's nose cone, or onto an outer surface of the aircraft. When a radome is attached to an outer surface, a metal platform is typically required to support the radome and an attached fairing. The platform that is utilized is large and heavy, which contributes to the overall weight of the aircraft. The platform is also usually expensive, thereby adding to the cost of the entire radome assembly. Also, many radome attachment methods result in pronounced difficulty when accessing the radome for service or repair. The preferred systems utilize a detachable radome while keeping the fairing structure attached.

Obviously, it would be very beneficial to provide an alternative method or structure for facilitating the attachment of a radome which protects/covers the antennas on an aircraft, or other vehicle. Optimally, a radome attachment method would provide a structure that would not require the use of a heavy metal platform and would include all, or more, of the protective capability of conventional attachment structures. An improved radome attachment structure would be a benefit for aircraft manufacturers, aircraft companies, aircraft service personnel, and any other company or individual who relies on the functionality and reliability of radome communication systems.

### DISCLOSURE OF THE INVENTION

A truss-reinforced radome crown structure (TRRCS) that functions in combination with an aircraft and a satellite communication (SAT-COM) system's radome or antenna. The TRRCS functions to maintain and protect a radome or antenna located on an exterior surface of an aircraft's fuselage. The preferred embodiment of the TRRCS includes an elliptical fairing having an outer surface, an inner surface, and a perimeter, and a truss structure that has a plurality of directionally alternating integral arms that are arranged as a series of sequential V shapes and horizontal connecting rods or tubes reinforcing the underlying frames that circumvent the inner surface of the fairing.

The truss structure's design and arm arrangement allows the TRRCS to absorb the forces when an aircraft's fuselage extends or contracts in diverse temperatures, as well as in varying environmental and atmospheric conditions.

The truss structure is attached to the fairing, and the fairing with attached truss is attached to the aircraft, by truss/fairing attachment means that comprise at least one combination of links/pins, rods or tubes. Preferably, a spherical bearing is used to secure the links/rods, or tubes and pins at each attachment location.

The fairing can be made of various materials including a non-laminated nut stretch formed monolithic plastic, a laminated composite, epoxy resin, carbon fiber, or metal. The truss structure can also be made of various materials, with metal preferred.

Additionally, the TRRCS can include a hollow bulb seal with wick that is located around the fairing's perimeter. The bulb seal with wick is preferably made of rubber and has a wick which and facilitates rapid decompression by allowing air to escape, and air pressure to equalize, while preventing air from being forced under and into the crown structure at flight speeds.

Also, the TRRCS can utilize a lightning diverter that extends around the fairings inner perimeter. The diverter directs the path of a lightning strike to an aircraft's frame, or the chassis of a different type of vehicle.

In view of the above disclosure, the primary object of the invention is to provide a truss-reinforced radome crown structure that can securely attach, and protect, a radome or antenna on an aircraft or other vehicle.

In addition to the primary object, it is also an object of the invention to provide a truss-reinforced radome crown structure that:
allows the airframe and skins to expand and contract,
is lightweight, strong yet allows airframe flexibility,
is easy to install and requires less install time than other related crown structures,
is long-lasting and durable,
can be used for any type of aircraft, made by an aircraft manufacturer,
can be used for various types/designs of radomes or antennas,
can be retrofitted onto existing aircraft,
uses attachment means that tie the fairing and the radome together, with load paths traveling through the aircraft's fuselage lugs to the underlying airframe,
can be installed quickly by use of a proprietary Octopus Style install tool,
requires minimal under skin/or interior intercostals or interior frame reinforcements,
is cost effective from both a manufacturer's and purchaser's point of view.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is a side elevational view of a truss-reinforced radome crown structure (TRRCS).

FIG. 2 is an orthographic isometric cutaway view of a truss-reinforced radome crown structure (TRRCS).

FIG. 3 is a top orthographic view of the TRRCS shown with two radomes/antennas.

FIG. 4 is a side elevational view of the TRRCS shown with an upper section attached.

FIG. 5 is a top orthographic view of the TRRCS show with a hollow bulb seal with wick around the perimeter.

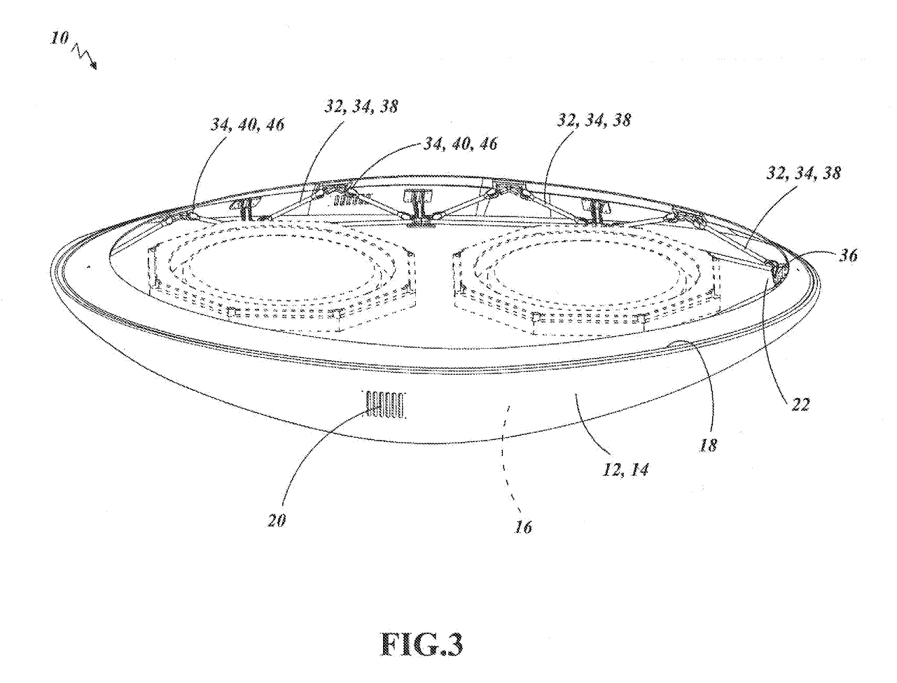

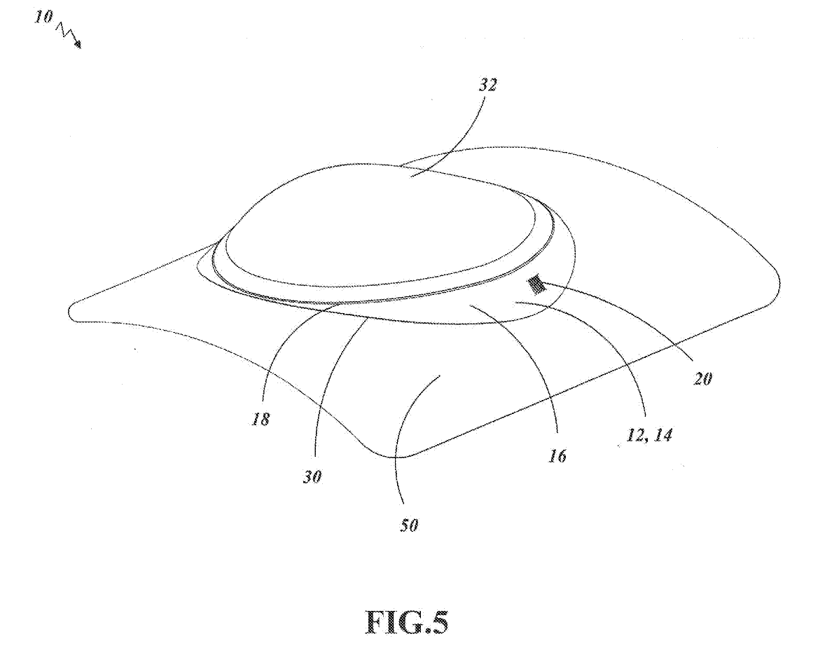

Please note that the antenna and antenna adapter plate shown in FIGS. 3 and 5 are not part of the invention and are shown for illustrative purposes only.

### BEST MODE FOR CARRYING OUT THE INVENTION

The best mode for carrying out the invention is presented in terms that disclose a preferred embodiment of a truss-reinforced radome crown structure (TRRCS 10). In order to facilitate mobile communications, certain vehicles such as aircraft utilize radomes as an essential component of a modern communication system. Typically, a SAT COM radome is attached to an upper section of an aircraft's fuselage. As a result of the attachment location, a radome can be subjected to extreme forces that result in significant wear and tear and structural damage. A conventional method of attaching a radome onto an aircraft includes the use of a heavy machined or fabricated metal platform which is attached between the aircraft and the radome. The primary functionality of a platform is to direct loads and stresses to reinforced attachment points.

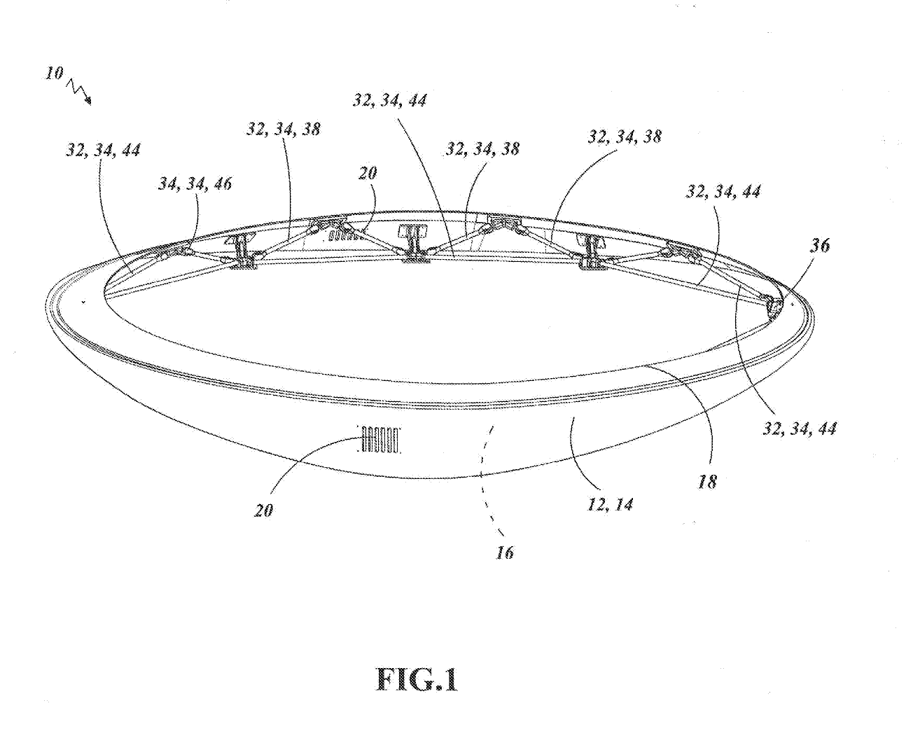

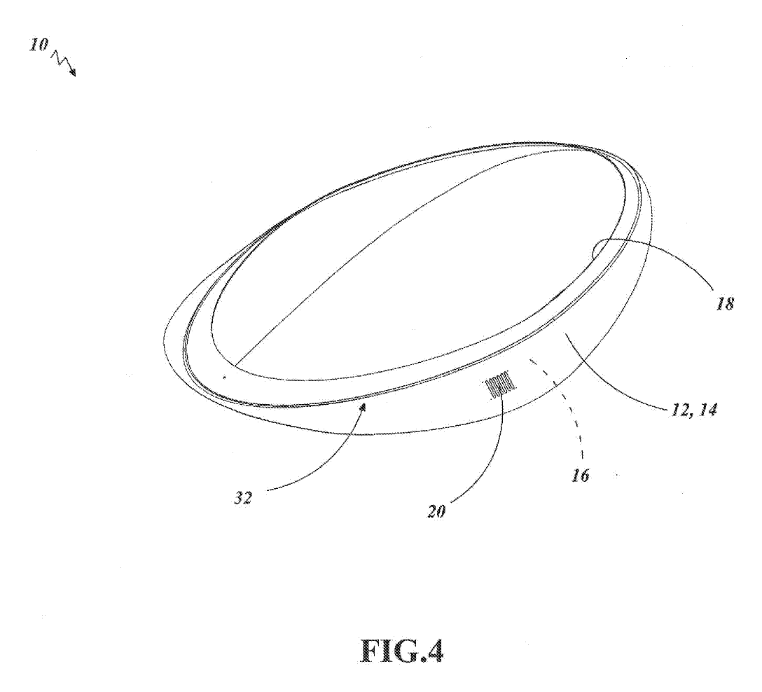

The TRRCS 10, as shown in FIGS. 1-5, provides attachment and protection of an antenna or radome while eliminating the necessity of the metal platform. The removal of the metal platform significantly reduces weight and cost compared to other current radome attachment structures.

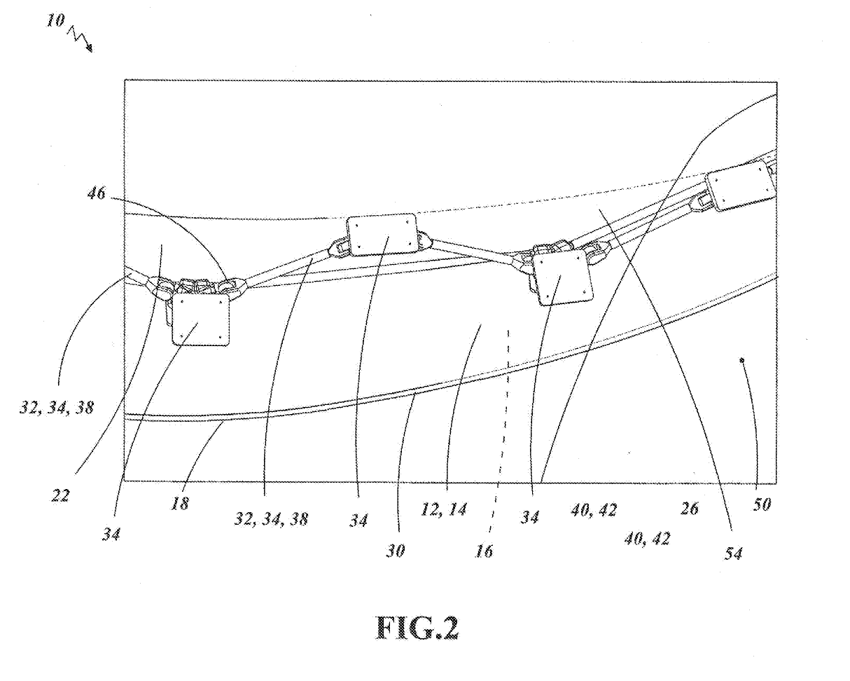

The TRRCS 10 is shown attached to an aircraft 50 in FIGS. 2 and 5, and is comprised of the following major elements: a fairing 12, truss fairing attachment means 34 and a truss structure 32 that circumvents the interior of the fairing.

The fairing 12, as shown in FIGS. 1-5, is comprised of an outer surface 14, an inner surface 16, and a perimeter 18. The fairing 12 can be any shape or size, depending on the dimensions of the radome and the fairing 12 can also be manufactured in various designs. For the purpose of this disclosure, a fairing 12 having an elliptical aerodynamic shape will be described and shown. The fairing 12 can be made of various materials including non-laminated nut stretch formed monolithic plastic such as polycarbonate or acrylic, a laminated composite, epoxy resin or carbon fiber. A metal such as aluminum can also be effectively utilized.

The main inventive element of the TRRCS 10 is the truss structure 32, as shown in FIGS. 1-5. The truss structure 32 facilitates the secure attachment of the fairing 12 without the requirement of a metal platform. As shown in FIG. 1, the truss structure 32 is attached to the fairing 12 by truss/fairing attachment means 34 that utilize a combination of links/rods 38 or tubes and pins 40, including exterior horizontal intercostal rods 44 or tubes. It should be noted that the use of the intercostal rods 44 or tubes, as shown in FIG. 1, causes the TRRCS 10 to have increased structural integrity and to become stronger. The rods 44 or tubes actually function as exterior intercostals that are tied to the underlying frame. For a typical application, there are a minimum of one combination links/rods 38 and/or pins 40 arranged in a geometric pattern. The truss structure 32 is located within and along the inner perimeter of the fairing 12 along the inner surface. A spherical bearing 42, as shown in FIG. 2, is preferably used to secure the links/rods 38 or tubes and pins 40 at each attachment point. The links/rods 38 or tubes and pins 40 are made of a metal such as aluminum or stainless steel, or a composite material such as epoxy fiber or carbon fiber. The material used to make the links/rods or tubes and pins is processed and treated to meet aerospace (or other) specifications, and can be coated for various weather or atmospheric conditions.

The proprietary geometrical design of the truss structure allows an aircraft's fuselage or sub structure to expand or contract freely, as the TRRCS 10 is designed to be used in diverse temperatures, as well as varying environmental and atmospheric conditions. Also, the inventive truss design allows for the use of the monolithic polycarbonate or nut stretched plastic which have lower tensile strength than composites but possess similar structural properties as a laminated composite material when attached in combination with a truss structure.

The fairing 12, whether made from nut stretched monolithic plastic or a composite material, includes a structural/lightning diverter 22, as shown in FIG. 3, which extends around the inner perimeter 18 of the fairing 12. The purpose of the structural/lightning diverter 22 is to direct the path of a lightning strike(s) to an aircraft's frame or a vehicle's chassis.

Additionally, the structural/lightning diverter 22, whether made of aluminum reinforcement strips or formed backing plates will enhance the strength of the TRRCS 10 by providing increased structural reinforcement that adds more rigidity where radome attaches. This also allows the TRRCS 10 to withstand other potentially damaging incidents such as a bird strike.

After the truss structure 32 is attached to fairing 12, the entire assembly is attached to the aircraft 50 by the fairing/aircraft attachment means 34 which are also comprised of the links/rods 38 or tubes and pins 40. The fairing 12 is attached to the aircraft's skinned sub structure and frames by the truss/fairing attachment means 34, which preferably are comprised of the links-/rods 38 and pins 40, the attachment means 34 can also utilize other devices. Functioning in combination with links/rods 38 and pins 40 as an element of the attachment means 34 is a hollow resilient perimeter bulb seal with wick 30 that is located around the fairing's perimeter. The hollow bulb seal with wick 30, with wick can be made of a variety of rubber to allow the seal to provide a positive interface. The hollow bulb seal with wick 30 will be compressed approximately fifty percent to allow for an elastic fit. The wick faces outward and prevents air from being forced under and into the crown structure at flight speeds.

Depending on the design of the TRRCS 10, the attachment means 34, as shown in FIGS. 1-3, can be hard mounted to the fairing 12 and aircraft's fuselage 50, or to the fairing 12 and chassis when a vehicle other than an aircraft is utilized. It should be noted that the attachment means are not required to be comprised of the links and rods or tubes used for the truss structure 34. The fairing 12 can have side air vents (not shown) to allow an equalization of pressures which reduces weight and stress.

The attachment means 34 are made of a metal and all attachments are capable of handling all load requirements. The attachment means 34 can have metal bushings (or sleeves) to protect the fairing 12 when the attachment means 34 are used to secure the fairing 12.

To add to the utility of the TRRCS 10, the truss/fairing can also have attachment means 34 be comprised of retainable floating quick-release screws and floating nut plates (not shown), and a fitting receptacle (not shown) capable of complying with the load requirements of the radome.

In conclusion, it is important to note that while the TRRCS 10 is designed for use with current radome communication technology, it is anticipated that the TRRCS 10 can be adapted for use with other systems currently in use or not yet produced. As previously disclosed, the TRRCS 10 is especially effective for use on an aircraft, but can also be used on other vehicle such as a train, automobile or ship, or even for other non-vehicular applications.

Additionally, other benefits of the TRRCS 10 are:

1. The exterior horizontal rods or tubes alter the location of the TRRCS structural modifications and enhancements from the aircraft's underlying structure to the exterior. There is no need for the additional several days of work installing underlying intercostals to support the TRRCS 10. The stronger, lighter TRRCS installs in a comparatively short time over any other crown structure in the industry.

2. As the TRRCS 10 is stronger, the thickness of the fairing's surfaces can be minimal. The load requirements are carried through the TRRCS 10 to the existing underlying airframe. The fairing surface thickness can be reduced from the standard 0.250 to 0.350 to 0.140 to 0.160. This saves weight, the cost of fairing composite material and the time required to construct a thicker fairing.

3. The TRRCS 10 is scalable. The TRRCS design can be used to build a multitude of crown structures to fit any and all makes and models of airframes, radome and antenna designs.

4. The TRRCS 10 exterior fuselage attach points are on aircraft frames or an underlying airframe structure.

5. During installation of the TRRCS 10 miss-drills are greatly minimized.

6. Radome/antenna mounts that are used with the TRRCS 10 are installed across the aircraft's frame fuselage attachment lugs with minor frame reinforcements; there is no need for expensive interior intercostals. The TRRCS 10 installs easily and actually provides the same structural enhancements as adding interior intercostals but without the time and expense of rebuilding the aircraft's interior frame structure. Both retro-fit and new design installations can be completed in a fraction of the time it takes to install the standard ARINC 791 or other designs using heavy adapter plate style crown structures currently used throughout the industry.

7. The TRRCS 10 can utilize captive radome attachment means. The fairing includes the proprietary hollow bulb seal with wick which allows air to escape if a decompression event occurs and prevents air from entering while the aircraft is traveling at flight speeds.

While the invention has been described in detail and pictorially shown in the accompanying drawings it is not to be limited to such details, since many changes and modification may be made to the invention without departing from the spirit and the scope thereof. Hence, it is described to cover any and all modifications and forms which may come within the language and scope of the claims.

1. A truss-reinforced radome crown structure (TRRCS) that functions in combination with an aircraft and a radome or antenna, wherein said TRRCS functions to maintain a radome or antenna on an exterior surface of an aircraft or other vehicle and is comprised of a fairing and a truss structure, wherein said truss structure is located around, and attached to, an interior perimeter of said fairing, wherein said fairing with said attached truss structure are interfaced with radome that is located on an exterior surface of an aircraft's fuselage, wherein said fairing with said attached truss structure are attached onto the aircraft's fuselage, interfacing with the radome, wherein once attached, said TRRCS maintains and protects the radome and antenna.

2. The TRRCS as specified in claim 1 wherein said fairing is made of a material selected from the group consisting of plastic, a composite, epoxy resin, carbon fiber or metal.

3. The TRRCS as specified in claim 2 wherein the plastic is comprised of a non-laminated nut stretch formed monolithic plastic.

4. The TRRCS as specified in claim 2 wherein the composite material is selected from the group consisting of a laminated material, infused plastic or epoxy.

5. The TRRCS as specified in claim 1 wherein the aircraft is selected from the group consisting of commercial aircraft, military aircraft, government aircraft, or personal/non-commercial aircraft.

6. The TRRCS as specified in claim 1 wherein the radome and antenna are utilized for satellite communication (SAT-COM).

7. The TRRCS as specified in claim 1 wherein said truss is attached to said fairing and said truss and fairing is attached to the aircraft by truss/fairing attachment means that comprise at least one combination of links/rods or tubes and pins.

8. The TRRCS as specified in claim 7 wherein the links/rods or tubes and pins are arranged in a geometric pattern.

9. The TRRCS as specified in claim 1 wherein truss/fairing attachment means is further comprised of horizontal intercostal rods or tubes.

10. A truss-reinforced radome crown structure (TRRCS) that functions in combination with an aircraft and a satellite communication radome and antenna, wherein said TRRCS functions to maintain and protect a radome and antenna located on an exterior surface of an aircraft's fuselage, wherein said TRRCS is comprised of:
a) an elliptical fairing having an outer surface, an inner surface, and a perimeter,
b) a truss structure that circumvents the inner surface of said fairing, and
c) truss/fairing attachment means that comprise at least one combination of links/pins, or tubes and rods, wherein a spherical bearing is used to secure the links/rods or tubes and pins at each attachment location, wherein said truss/fairing attachment means are utilized to attach said truss to said fairing, and said fairing with attached truss to the aircraft's fuselage, wherein once attached, said TRRCS interfaces with the radome, thereby maintaining and protecting the radome and antenna.

11. The TRRCS as specified in claim 10 wherein said fairing is made of a material selected from the group consisting of a non-laminated nut stretch formed monolithic plastic, a laminated composite, epoxy resin, carbon fiber or metal.

12. The TRRCS as specified in claim 10 wherein said truss structure's design allows said TRRCS compensate for the forces when an aircraft's fuselage or sub-structure expands or contracts in diverse temperatures as well as in varying environmental and atmospheric conditions.

13. The TRRCS as specified in claim 10 wherein the aircraft is selected from the group consisting of commercial aircraft, military aircraft, government aircraft, or personal/non-commercial aircraft.

14. The TRRCS as specified in claim 10 wherein the links/rods or tubes and pins are arranged in a geometric pattern.

15. The TRRCS as specified in claim 10 wherein the truss/fairing attachment means comprises a hollow bulb seal with wick that is located around said fairing's perimeter, wherein said seal with wick is made of rubber and facilitates rapid decompression by allowing pressurized air to escape and air pressure to equalize, while preventing air from intruding under said fairing.

16. The TRRCS as specified in claim 10 wherein said truss/fairing attachment means further comprises a plurality of exterior horizontal intercostal rods or tubes that increase the structural integrity of said TRRCS.

17. The TRRCS as specified in claim 10 wherein said truss/fairing attachment means are comprised of retainable floating quick-release screws and floating nut plates that function in combination with a fitting receptacle.

18. The TRRCS as specified in claim 10 further comprising a lighting diverter that extends around said fairing's inner perimeter, wherein said diverter directs a path of a lighting strike to an aircraft's frame, or a chassis if a different type of vehicle, wherein said diverter is made of aluminum reinforced strips or formed backing plates, wherein said diverter also increases the structural integrity of said TRRCS including protection against bird strike incident as a forward leading inside edge is a reinforced formed backing plate.
